(19) United States
(12) Patent Application Publication
(10) Pub. No.: US 2026/0122338 A1
(43) Pub. Date: Apr. 30, 2026

(54) IMAGE PROCESSING APPARATUS, METHOD OF CONTROLLING THE SAME, IMAGING APPARATUS, AND STORAGE MEDIUM

(71) Applicant: CANON KABUSHIKI KAISHA, Tokyo (JP)

(72) Inventors: TOSHIHIKO SUGIMOTO, Kanagawa (JP); NOBUTAKA MIZUNO, Tokyo (JP); TOMOHIRO NISHIYAMA, Tokyo (JP)

(21) Appl. No.: 19/357,293

(22) Filed: Oct. 14, 2025

(30) Foreign Application Priority Data
Oct. 25, 2024 (JP) 2024-188543

(51) Int. Cl. H04N 23/63; H04N 13/111; H04N 13/156; H04N 13/00

(52) U.S. Cl. CPC H04N 23/635; H04N 13/111; H04N 13/156; H04N 2013/0081

(57) ABSTRACT

An image processing apparatus acquires a plurality of images captured in such a manner as to include a common subject and have parallax, determines a specific subject with occlusion among the plurality of images; and generates information enabling visual recognition of occlusion of the specific subject in a display image that is based on at least one of the plurality of images.

### BACKGROUND

### Field of the Technology

The present invention relates to an image processing apparatus, a method of controlling the image processing apparatus, an imaging apparatus, and a storage medium.

### DESCRIPTION OF THE RELATED ART

In recent years, there is known such an imaging apparatus that is capable of capturing stereoscopic images (hereinafter referred to as 3D video images or 3D images). An imaging apparatus has been proposed in which right and left images on corresponding sides of the center are captured by a single image sensor via a special binocular lens in an interchangeable lens camera to create parallax image data (Japanese Patent Laid-Open No. 2011-205558).

Another technique has been proposed to process a plurality of images captured by a compound eye lens with different viewpoints and combine them into a single display image for display (Japanese Patent Laid-Open No. 2013-138442 and No. 2012-124885).

Stereopsis is achieved by perceiving depth through parallax of a binocular image. If occlusion occurs, a situation may arise in which a subject is visible to one eye, but the subject is hidden to the other eye. In such a case, parallax information on the subject cannot be obtained since there is no subject correspondence between the two eyes. In other words, when 3D video images taken under such a condition are used, viewers may be unable to achieve normal stereopsis and may feel uncomfortable. On the other hand, if a photographer can properly understand occlusion of the subject during imaging, it becomes easy to capture 3D video images as intended by the photographer. The aforementioned three patent documents do not take into account that the photographer easily understands the occlusion.

### SUMMARY

The present disclosure is directed to a technique that enables a photographer to visually recognize occlusion occurrence of a subject easily.

In order to solve the aforementioned issues, one aspect of the present disclosure provides an image processing apparatus, comprising: at least one processor; and at least one memory coupled to the at least one processor storing instructions that, when executed by the at least one processor, cause the at least one processor to function as: an image acquisition unit configured to acquire a plurality of images captured in such a manner as to include a common subject and have parallax; a determining unit configured to determine a specific subject with occlusion among the plurality of images; and a generating unit configured to generate information enabling visual recognition of occlusion of the specific subject in a display image that is based on at least one of the plurality of images.

Another aspect of the present disclosure provides a method of controlling an image processing apparatus, the method comprising: acquiring a plurality of images captured in such a manner as to include a common subject and have parallax; determining a specific subject with occlusion among the plurality of images; and generating information enabling visual recognition of occlusion of the specific subject in a display image that is based on at least one of the plurality of images.

Still another aspect of the present disclosure provides a non-transitory computer-readable storage medium comprising instructions for performing a method of controlling an image processing apparatus, the method comprising: acquiring a plurality of images captured in such a manner as to include a common subject and have parallax; determining a specific subject with occlusion among the plurality of images; and generating information enabling visual recognition of occlusion of the specific subject in a display image that is based on at least one of the plurality of images.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are each an external configuration example of a camera according to a first embodiment.

FIG. 2 is an internal configuration example of the camera according to the first embodiment.

FIG. 3 is a schematic view illustrating a configuration example of a lens unit according to the first embodiment.

FIG. 4 is a block diagram illustrating an example of a functional configuration according to the first embodiment.

FIG. 5 is a flowchart illustrating operation of occlusion information generation processing according to the first embodiment.

FIG. 6 is a diagram explaining an example of a shooting scene according to the first embodiment.

FIG. 7 is a diagram explaining an example of a captured image according to the first embodiment.

FIG. 8 is a diagram explaining selection of a main subject according to the first embodiment.

FIG. 9 is a diagram explaining a base image according to the first embodiment.

FIG. 10 is a diagram explaining an example of an occlusion display image according to the first embodiment.

FIG. 11 is a diagram explaining a base image according to a second embodiment.

FIG. 12 is a diagram explaining an example of an occlusion display image according to the second embodiment.

FIG. 13 is a diagram explaining one aspect of an occlusion display image according to a third embodiment.

FIG. 14 is a diagram explaining another aspect of the occlusion display image according to the third embodiment.

### DESCRIPTION OF THE EMBODIMENTS

### First Embodiment

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

The following describes an example as one example of an image processing apparatus that uses a digital camera capable of processing a plurality of images with parallax. However, the present embodiment is not limited to a digital camera, but is applicable to other devices capable of processing a plurality of images with parallax. Examples of the devices may include a smartphone, a game console, a tablet terminal, a wearable information terminal, and a medical device.

### Overall Hardware Configuration

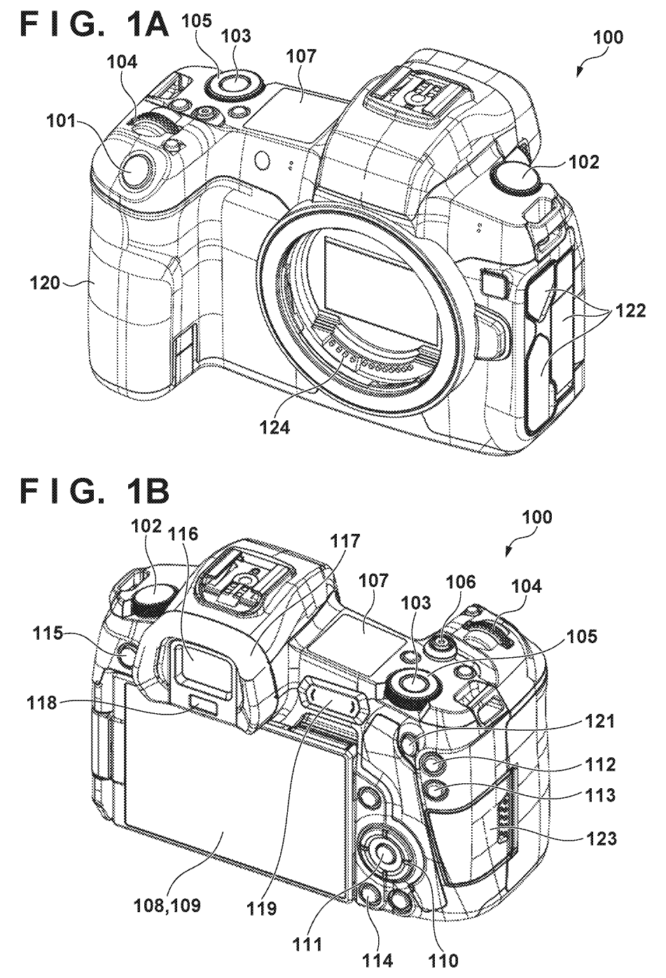

FIGS. 1A and 1B illustrate examples of outer appearances of a digital camera 100 (hereinafter simply referred to as a camera). FIG. 1A is a perspective view illustrating the camera 100 in sight of its front face, and FIG. 1B is a perspective view illustrating the camera 100 in sight of its rear face.

The camera 100 includes a shutter button 101, a power switch 102, a mode selection switch 103, a main electronic dial 104, a sub electronic dial 105, a moving image button 106, and an out-of-finder display unit 107 on its top face. The shutter button 101 is an operation member to perform an image capturing preparation or issue an image capturing instruction. The power switch 102 is an operation member to turn power of the camera 100 ON or OFF. The mode selection switch 103 is an operation member to select various modes. The main electronic dial 104 is a rotary operation member to change setting values of a shutter speed, diaphragm, and other properties. The sub electronic dial 105 is a rotary operation member to move a selection frame (cursor), to feed images, and the like. The moving image button 106 is an operation member to issue instructions for starting and stopping moving image capturing (recording). The out-of-finder display unit 107 displays various setting values of the shutter speed, diaphragm, and other properties.

The camera 100 includes a display unit 108, a touch panel 109, a cross key 110, a SET button 111, an automatic exposure (AE) lock button 112, an enlargement button 113, a reproduction button 114, a menu button 115, an eyepiece portion 116, an eye contact detection unit 118, and a touch bar 119 on its rear face. The display unit 108 displays images and various pieces of information. The touch panel 109 is an operation member to detect touch operations on a display surface (touch operation surface) of the display unit 108. The cross key 110 is an operation member including up, down, right, and left keys (four-way key) capable of pressing. The cross key 110 allows operation according to its pressed position. The SET button 111 is an operation member to be pressed mainly to determine a selection item. The AE lock button 112 is an operation member to be pressed to fix an exposure state in an image capturing standby state. The enlargement button 113 is an operation member to turn an enlargement mode ON or OFF in a live view display (LV display) in the image capturing mode. With the enlargement mode ON, operating the main electronic dial 104 enlarges or reduces a live view image (LV image). The enlargement button 113 is used to enlarge reproduced images or increase a magnification rate in a reproduction mode. The reproduction button 114 is an operation member to switch between the image capturing mode and the reproduction mode. Pressing the reproduction button 114 in the image capturing mode shifts the camera 100 to the reproduction mode, making it possible to display the latest one of the images recorded in a storage medium 228, described below, in the display unit 108.

The menu button 115 is an operation member to be pressed to display a menu screen for making various settings in the display unit 108. A user is able to intuitively make various settings on the menu screen displayed on the display unit 108 with the cross key 110 and the SET button 111. The eyepiece portion 116 is provided with an eye contact finder (look-in finder) 117 to be brought to the user’s eye. The eyepiece portion 116 allows the user to visually recognize an image displayed on an internal electronic view finder (EVF) 217, described below. The eye contact detection unit 118 is a sensor to detect whether the user’s eye is close to the eyepiece portion 116.

The touch bar 119 is a line-shaped touch operation member (line touch sensor) capable of accepting touch operations. The touch bar 119 is disposed at a (touchable) position where touch operations can be performed with the thumb of the right hand while holding a grip portion 120 with the right hand (the little finger, the ring finger, and the middle finger of the right hand) so that the shutter button 101 can be pressed with the forefinger of the right hand. Specifically, the touch bar 119 can be operated with the user’s eye close to the eyepiece portion 116 to look in the eye contact finder 117 in a state in which the user is poised to press the shutter button 101 at any time (photographing attitude). The touch bar 119 is capable of accepting tap operations (touching the touch bar 119 and then detaching the finger without moving it within a predetermined time period), and right/left slide operations (touching the touch bar 119 and then moving the touch position while in contact with the touch bar 119). The touch bar 119 is an operation member different from the touch panel 109 and is not provided with a display function. The touch bar 119 according to the present embodiment is a multifunction bar, and functions, for example, as an M-Fn bar.

The camera 100 also includes the grip portion 120, a thumb rest portion 121, terminal covers 122, a lid 123, and a communication terminal 124. The grip portion 120 is a holding member shaped so as to be easy to grip with the right hand when the user holds the camera 100. The shutter button 101 and the main electronic dial 104 are disposed at positions where they can be operated by the forefinger of the right hand while holding the camera 100 by gripping the grip portion 120 with the little finger, the ring finger, and the middle finger of the right hand. The sub electronic dial 105 and the touch bar 119 are disposed at positions where they can be operated by the thumb of the right hand in a similar state. The thumb rest portion 121 (thumb standby position) is a grip portion provided at a position on the rear face of the camera 100, where the thumb of the right hand holding the grip portion 120 is easy to rest in a state where no operation member is operated. The thumb rest portion 121 is made of a rubber material and the like to improve the holding force (grip feeling). The terminal covers 122 protect connectors such as connection cables for connecting the camera 100 to external devices. The lid 123 closes a slot for storing the storage medium 228, described below, to protect the storage medium 228 and the slot. The communication terminal 124 enables the camera 100 to communicate with a lens unit 200, described below, which is attachable to and detachable from the camera 100.

### Internal Configuration of Camera

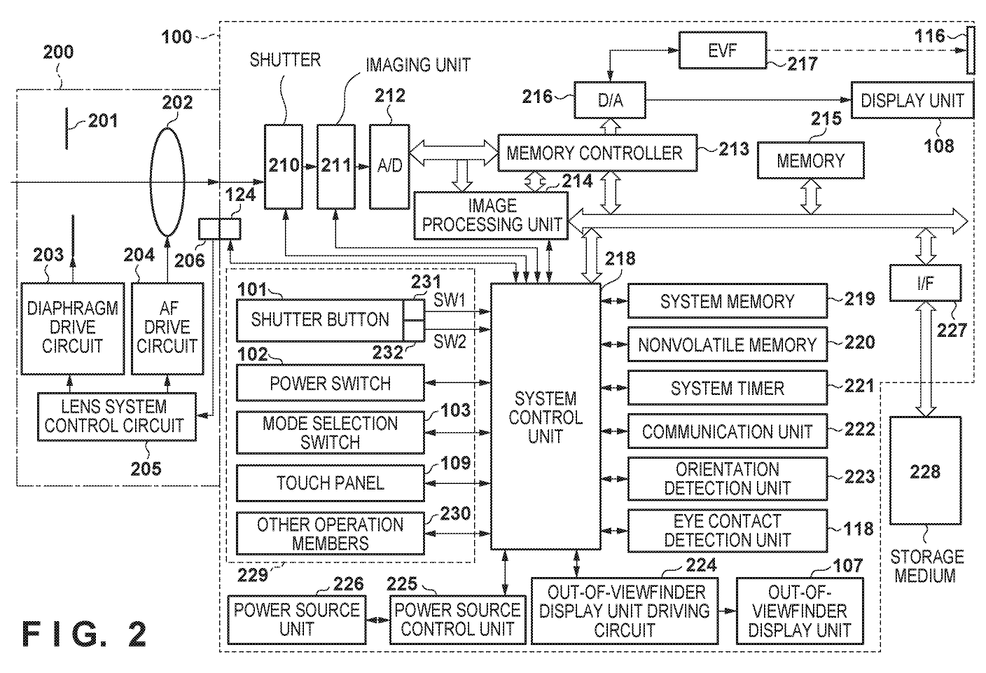

FIG. 2 illustrates an internal configuration example of the camera 100. Referring to FIGS. 1A and 1B, like numbers refer to like components in FIG. 2, and redundant descriptions thereof will be omitted as appropriate. The lens unit 200 is attached to the camera 100.

The following first describes the lens unit 200.

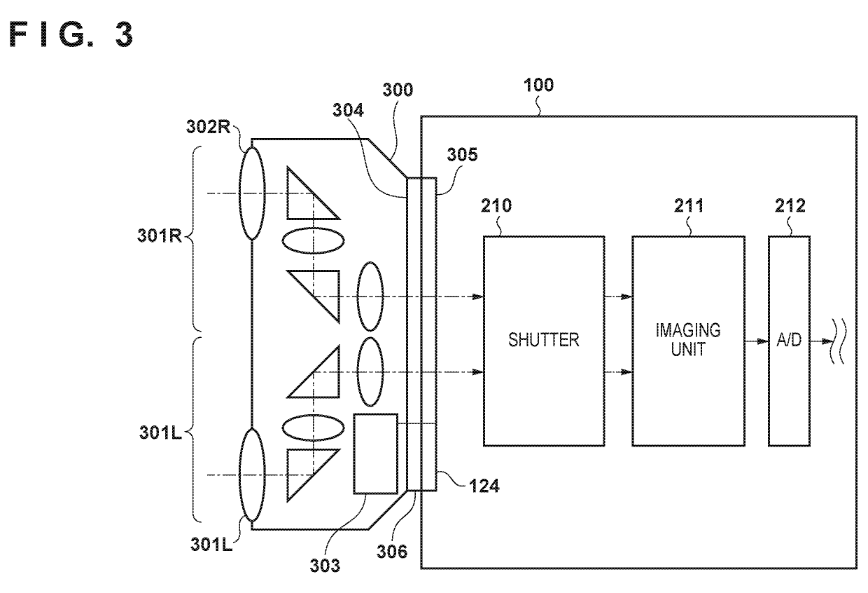

The lens unit 200 is a type of interchangeable lens attachable to and detachable from the camera 100. The lens unit 200 includes a single-lens as an example of a regular lens. Although the example of the single-lens is described here for simplification of explanation of the hardware configuration, a binocular lens according to the present embodiment, which is to be described below with reference to FIG. 3, can be attached.

The lens unit 200 includes a diaphragm 201, a lens 202, a diaphragm drive circuit 203, an automatic focus (AF) drive circuit 204, a lens system control circuit 205, and a communication terminal 206.

The diaphragm 201 has an adjustable aperture diameter. The lens 202 includes a plurality of lenses. The diaphragm drive circuit 203 controls an aperture diameter of the diaphragm 201 to adjust a quantity of light. The AF drive circuit 204 drives the lens 202 to adjust a focus. The lens system control circuit 205 controls the diaphragm drive circuit 203, the AF drive circuit 204, and the like based on instructions from a system control unit 218 described below. The lens system control circuit 205 controls the diaphragm 201 via the diaphragm drive circuit 203 and shifts a position of the lens 202 via the AF drive circuit 204 to adjust the focus. The lens system control circuit 205 can communicate with the camera 100. Specifically, the lens system control circuit 205 communicates with the camera 100 via the communication terminal 206 of the lens unit 200 and the communication terminal 124 of the camera 100. The communication terminal 206 is used by the lens unit 200 to communicate with the camera 100.

The camera 100 will be described next. The camera 100 includes a shutter 210, an imaging unit 211, an analog-to-digital (A/D) converter 212, a memory controller 213, an image processing unit 214, a memory 215, a digital-to-analog (D/A) converter 216, the EVF 217, the display unit 108, and the system control unit 218.

The shutter 210 is a focal-plane shutter to freely control an exposure time of the imaging unit 211 based on instructions from the system control unit 218. The imaging unit 211 is an image sensor that is a charge coupled device (CCD) sensor or a complementary metal oxide semiconductor (CMOS) sensor to convert an optical image into an electric signal. Note that exposure control performed using the shutter 210 can also be realized by controlling the imaging unit 211 (electronic shutter). In this case, it is also possible to have a configuration in which the shutter 210 is removed from the imaging apparatus (mechanical shutterless). The imaging unit 211 may include an imaging plane phase-difference sensor to output defocus amount information to the system control unit 218. The A/D converter 212 converts an analog signal output from the imaging unit 211 into a digital signal. The image processing unit 214 performs predetermined processing (e.g., pixel interpolation, resize processing including reduction, and color conversion processing) on data from the A/D converter 212 or from the memory controller 213. The image processing unit 214 also performs predetermined calculation processing on captured image data. The system control unit 218 performs exposure control and distance measurement control based on obtained calculation results. This processing enables AF processing, automatic exposure (AE) processing, and electronic flash preliminary emission (EF) processing, and the like, based on a through-the-lens (TTL) method. The image processing unit 214 also performs predetermined calculation processing on the captured image data and performs TTL-based automatic white balance (AWB) processing based on obtained calculation results.

Image data from the A/D converter 212 is stored in the memory 215 via the image processing unit 214 and the memory controller 213. Otherwise, image data from the A/D converter 212 is stored in the memory 215 via the memory controller 213 without being processed by the image processing unit 214. The memory 215 stores image data, captured by the imaging unit 211 and then converted into digital data by the A/D converter 212, and image data to be displayed on the display unit 108 and the EVF 217. The memory 215 has a sufficient storage capacity to store a predetermined number of still images, and moving images and sound of a predetermined time period. The memory 215 also serves as an image display memory (video memory). Moreover, the memory 215 may store data on occlusion information (occlusion display image) generated by occlusion information generation processing described below.

The D/A converter 216 converts image display data stored in the memory 215 into an analog signal and then supplies the signal to the display unit 108 and the EVF 217. Thus, the image display data stored in the memory 215 is displayed on the display unit 108 and EVF 217 via the D/A converter 216. The display unit 108 and the EVF 217 display data corresponding to the analog signal from the D/A converter 216. The display unit 108 and the EVF 217 are, for example, a liquid crystal display (LCD) and an organic electroluminescence (EL) display. The digital signal, generated in the A/D conversion by the A/D converter 212 and stored in the memory 215, is then converted into an analog signal by the D/A converter 216. The analog signal is successively transferred to the display unit 108 or the EVF 217 and displayed thereon, thus enabling the LV display. The display unit 108 and the EVF 217 can also display the occlusion information described below.

The system control unit 218 includes at least one processor and/or at least one circuit. Specifically, the system control unit 218 may be a processor, a circuit, or a combination of both. The system control unit 218 controls the whole camera 100. The system control unit 218 runs programs recorded in a nonvolatile memory 220 to carry out each piece of processing of a flowchart described below. The system control unit 218 also controls the memory 215, the D/A converter 216, the display unit 108, the EVF 217, and the like to perform display control.

The camera 100 also includes a system memory 219, the nonvolatile memory 220, a system timer 221, a communication unit 222, an orientation detection unit 223, and the eye contact detection unit 118.

The system memory 219 is, for example, a random access memory (RAM). Constants and variables used for operations of the system control unit 218 and programs read from the nonvolatile memory 220 are loaded into the system memory 219.

The nonvolatile memory 220 is an electrically erasable recordable memory such as an electrically erasable programmable read only memory (EEPROM). Constants and programs used for operations of the system control unit 218 are recorded in the nonvolatile memory 220. The above-described programs refer to programs for carrying out the processing in a flowchart described below.

The system timer 221 is a time measurement unit to measure time used in various control and time of the built-in clock. The communication unit 222 transmits and receives video and audio signals to and from an external device wirelessly connected or connected with a wire cable thereto. The communication unit 222 is connectable with a wireless Local Area Network (LAN) and the Internet. The communication unit 222 is also able to communicate with an external device through Bluetooth (registered trademark) and Bluetooth Low Energy.

The communication unit 222 can transmit images (including the live image) captured by the imaging unit 211 and images recorded in the storage medium 228, and can receive image data and other various pieces of information from an external device.

The orientation detection unit 223 detects orientation of the camera 100 with respect to a gravity direction. Based on the orientation detected by the orientation detection unit 223, it can be determined whether the image captured by the imaging unit 211 is an image captured with the camera 100 horizontally held or an image captured with the camera 100 vertically held. Also, the system control unit 218 can add direction information corresponding to the orientation detected by the orientation detection unit 223 to an image file of the image captured by the imaging unit 211, or rotate the image before recording. An acceleration sensor or a gyroscope sensor can be used as the orientation detection unit 223, for example. Motions of the camera 100 (pan, tilt, raising, and stand still) can also be detected by using the orientation detection unit 223.

The eye contact detection unit 118 can detect approach of some object to the eyepiece portion 116 of the eye contact finder 117 incorporating the EVF 217. An infrared light proximity sensor can be used as the eye contact detection unit 118. When an object comes closer, infrared light projected from a light projecting portion of the eye contact detection unit 118 is reflected by the object and then received by a light receiving portion of the infrared light proximity sensor. A distance between the eyepiece portion 116 and the object can be determined based on a quantity of the received infrared light. In this manner, the eye contact detection unit 118 performs eye contact detection to detect the proximity distance of the object to the eyepiece portion 116. The eye contact detection unit 118 is an eye contact detection sensor to detect approach (eye-on state) and separation (eye-off state) of the eye (object) to and from the eyepiece portion 116 of the eye contact finder 117. When an object coming closer to the eyepiece portion 116 is detected at a predetermined distance or shorter in the eye-off state (non-approaching state), the eye-on state is detected. On the other hand, when an object in the eye-on state (approaching state) is detached and separated from the eyepiece portion 116 by a predetermined distance or longer, the eye-oft state is detected. A threshold value for detecting the eye-on state and a threshold value for detecting the eye-off state may be different, for example, by providing a hysteresis. Once the eye-on state is detected, the eye-on state continues until the eye-off state is detected. Once the eye-off state is detected, the eye-off state continues until the eye-on state is detected. The system control unit 218 turns display of the display unit 108 and the EVF 217 ON (display state) or OFF (undisplay state) depending on the state detected by the eye contact detection unit 118. Specifically, at least when the camera 100 is in the image capturing standby state and when an automatic changeover is set for the display destination, the following display control is performed. In the eye-off state, the display unit 108 is set as the display destination, i.e., the display of the display unit 108 is turned ON, and the display of the EVF 217 is turned OFF. In the eye-on state, the EVF 217 is set as the display destination, i.e., the display of the EVF 217 is turned ON, and the display of the display unit 108 is turned OFF. The eye contact detection unit 118 is not limited to an infrared proximity sensor but may be another sensor as long as the sensor is capable of detecting the eye-on state.

The camera 100 also includes the out-of-finder display unit 107, an out-of-finder display drive circuit 224, a power source control unit 225, a power source unit 226, a storage medium interface (I/F) 227, and an operating unit 229. The out-of-finder display unit 107 displays various setting values to the camera 100, such as the shutter speed and diaphragm, via the out-of-finder display drive circuit 224.

The power source control unit 225 includes a battery detection circuit, a direct-current to direct-current (DC-DC) converter, and a switch circuit to select a block to be supplied with power. The power source control unit 225 detects attachment or detachment of a battery, battery types, a remaining battery capacity, and the like. The power source control unit 225 also controls a DC-DC converter based on its detection results and instructions from the system control unit 218 to supply appropriate voltages to the storage medium 228 and other components for appropriate time periods. The power source unit 226 includes a primary battery such as an alkaline battery and a lithium battery, a secondary battery such as a NiCd battery, a NiMH battery, and a Li battery, and an alternating current (AC) adapter. The storage medium I/F 227 is an interface to the storage medium 228 such as a memory card and a hard disk. The storage medium 228 is, for example, a memory card to record captured images, and includes a semiconductor memory or a magnetic disk. The storage medium 228 may be attachable to and detachable or built-in.

The operating unit 229 is an input unit to accept operations from the user (user operations) and is used to input various instructions to the system control unit 218. The operating unit 229 includes the shutter button 101, the power switch 102, the mode selection switch 103, the touch panel 109, and other operation members 230. Other operation members 230 include the main electronic dial 104, the sub electronic dial 105, the moving image button 106, the cross key 110, the SET button 111, the AE lock button 112, the enlargement button 113, the reproduction button 114, the menu button 115, and the touch bar 119.

The shutter button 101 includes a first shutter switch 231 and a second shutter switch 232. The first shutter switch 231 turns ON in the middle of the operation on the shutter button 101, what is called a half depression (image capturing preparation instruction), to generate a first shutter switch signal SW1. In response to the first shutter switch signal SW1, the system control unit 218 starts image capturing preparation processing such as the AF processing, AE processing, AWB processing, and EF processing. The second shutter switch 232 turns ON upon completion of the operation on the shutter button 101, what is called a full depression (image capturing instruction), to generate a second shutter switch signal SW2. In response to the second shutter switch signal SW2, the system control unit 218 starts a series of image capturing processing including reading the signal from the imaging unit 211, generating an image file containing a captured image, and storing the image file in the storage medium 228.

The mode selection switch 103 changes the operation mode of the system control unit 218 to any of a still image capturing mode, a moving image capturing mode, and a reproduction mode. The still image capturing mode includes the automatic image capturing mode, automatic scene determination mode, manual mode, diaphragm priority mode (Av mode), shutter speed priority mode (Tv mode), and program AE mode (P mode), for example, but is not limited to these.

It is also possible to set various scene modes, custom modes, and the like, which are imaging settings for various captured scenes, via the mode selection switch 103. For example, the mode selection switch 103 enables the user to directly select any one of the above image capturing modes. Otherwise, the mode selection switch 103 enables the user to once select an image capturing mode list screen and then select any one of a plurality of displayed modes using the operating unit 229. Likewise, the moving image capturing mode may also include a plurality of modes.

The touch panel 109 is a touch sensor to detect various touch operations on the display surface of display unit 108 (operation surface of the touch panel 109). The touch panel 109 and the display unit 108 can be integrally formed. For example, the touch panel 109 is attached to the upper layer of the display surface of the display unit 108 so that the transmissivity of light does not disturb the display of the display unit 108. Then, the input coordinates on the touch panel 109 are associated with the display coordinates on the display surface of the display unit 108. This provides a graphical user interface (GUI) that allows the user to directly operate the screen displayed on the display unit 108 virtually. The touch panel 109 may be one among various types including a resistance film type, a capacitance type, a surface elastic wave type, an infrared type, an electromagnetic induction type, an image recognition type, and an optical sensor type. A touch is detected when a finger or pen comes into contact with the touch panel 109 or when a finger or pen comes close to the touch panel 109 depending on the type, and either type is applicable.

The system control unit 218 can detect the following operations or states of the touch panel 109:

- An operation to start touching the touch panel 109 with a finger or pen that had been out of contact with the touch panel 109 (hereinafter referred to as a “touch-down”);

- A state where the finger or pen is in contact with the touch panel 109 (hereinafter referred to as a “touch-on”);

- An operation to move the finger or pen while in contact with the touch panel 109 (hereinafter referred to as a “touch-move”);

- An operation to detach (release) the finger or pen that had been in contact with the touch panel 109 from the touch panel 109 to end touching (hereinafter referred to as a “touch-up”); and

- A state where the finger or pen is out of contact with the touch panel 109 (hereinafter referred to as a “touch-off”).

When a touch-down is detected, a touch-on is also detected at the same time. After detecting a touch-down, a touch-on is normally kept being detected until a touch-up is detected. When a touch-move is detected, a touch-on is also detected at the same time. Even when a touch-on is detected, a touch-move is not detected if the touch position is not moving. After a touch-up of all of the fingers or the pen that had been in contact with the touch panel is detected, a touch-off is detected.

The above-described operations and states as well as the position coordinates of the position where the finger or pen contacts the touch panel 109 are notified to the system control unit 218 via an internal bus. Based on the notified information, the system control unit 218 determines what kind of operation (touch operation) has been performed on the touch panel 109. For a touch-move, the moving direction of the finger or pen moving on the touch panel 109 can be determined for the individual vertical and horizontal components on the touch panel 109 based on changes in the position coordinates. If a touch-move over a predetermined distance or longer is detected, it is determined that a slide operation has been performed. An operation of quickly moving a finger over a certain distance while in contact with the touch panel 109 and then releasing the finger therefrom is referred to as a flick. In other words, a flick is an operation of flicking on a surface of the touch panel 109 with a finger. If a touch-move at a predetermined speed or higher over a predetermined distance or longer is detected and then a touch-up is subsequently detected, a flick is determined to have been performed (a flick is determined to have been performed following a slide). A touch operation of simultaneously touching a plurality of positions, for example, two positions (multi-touch) and bringing these positions close to each other is referred to as a “pinch-in”. A touch operation of moving these positions away from each other is referred to as a “pinch-out”. A pinch-out and a pinch-in are collectively referred to as a pinch operation (or simply referred to as a “pinch”).

### Configuration of Lens Unit

FIG. 3 is a schematic view illustrating a configuration example of the lens unit 300. FIG. 3 illustrates the camera 100 with the lens unit 300 attached thereto. Referring to the camera 100 illustrated in FIG. 3, like numbers refer to like components illustrated in FIG. 2, and redundant descriptions thereof will be omitted appropriately.

The lens unit 300 is one example of an interchangeable lens attachable to and detachable from the camera 100. The lens unit 300 is a binocular lens capable of capturing two images with parallax in right and left images. The lens unit 300, for example, has two optical systems, each with a wide viewing of approximately 180 degrees, and can capture a forward hemispheric range. Specifically, by using two optical systems of the lens unit 300, the camera 100 can capture images of subjects in viewing angles (field angle) of 180 degrees in the horizontal direction (horizontal angle, azimuth angle, and angle of yaw) and 180 degrees in the vertical direction (vertical angle, elevation angle, and angle of pitch).

The lens unit 300 includes a right-eye optical system 301R including a plurality of lenses and reflection mirrors, a left-eye optical system 301L including a plurality of lenses and reflection mirrors, and a lens system control circuit 303. The right-eye optical system 301R corresponds to an example of a first optical system, and the left-eye optical system 301L corresponds to an example of a second optical system. In the right-eye optical system 301R and the left-eye optical system 301L, respective lenses 302R and 302L are located on the subject side face in the same direction, and the optical axes thereof are substantially parallel. The lens unit 300 according to the present embodiment includes a Virtual Reality (VR) 180 lens to capture images for what is called VR180, a VR image format that enables binocular stereoscopic vision. The VR180 lens includes a fisheye lens in which both the right-eye optical system 301R and the left-eye optical system 301L capture images in a range of approximately 180 degrees. The right-eye optical system 301R and the left-eye optical system 301L in the VR180 lens only need to acquire an image that enables dual side-by-side VR image display in VR180, and the VR180 lens may be capable of capturing a wide viewing angle range of about 160 degrees smaller than the range of 180 degrees. The VR180 lens can form a right image (first image) formed through the right-eye optical system 301R and a left image (second image) formed through the left-eye optical system 301L with parallax to the right image on one or more image sensors of the attached camera 100. The lens unit 300 includes a focus ring for performing focus adjustment. Although not shown in FIG. 3, the lens unit 300 includes a focus ring for adjusting the focus of the right image formed through the right-eye optical system 301R and a focus ring for adjusting the focus of the left image formed through the left-eye optical system 301L. Alternatively, the lens unit 300 includes a focus ring that simultaneously adjusts the focus of the right image formed through the right-eye optical system 301R and the left image formed through the left-eye optical system 301L, and a focus ring that adjusts the focus of one of the right image or the left image.

The lens unit 300 is attached to the camera 100 via a lens mount unit 304 and a camera mount unit 305 of the camera 100. With the lens unit 300 attached to the camera 100, the system control unit 218 of the camera 100 and the lens system control circuit 303 of the lens unit 300 are electrically connected with each other via the communication terminal 124 of the camera 100 and the communication terminal 306 of the lens unit 300. The communication terminal 206 corresponds to the communication terminal 306.

According to the present embodiment, the right image formed through the right-eye optical system 301R and the left image formed through the left-eye optical system 301L with parallax to the right image are formed side by side on the imaging unit 211 of the camera 100. Specifically, the two optical images formed by the right-eye optical system 301R and the left-eye optical system 301L are formed on one image sensor. The imaging unit 211 converts the formed subject image (an optical signal) into an analog electrical signal. In this manner, by using the lens unit 300, two images with parallax can be acquired simultaneously (as a set) from two positions (optical systems), i.e., the right-eye optical system 301R and the left-eye optical system 301L. Additionally, by displaying the obtained image to divide into a right-eye image and a left-eye image for VR display, the user can view a three-dimensional VR image over a substantially 180-degree range, which is so-called VR180.

Here, the “VR image” is an image that can be displayed in VR described below. Examples of the VR image include an omnidirectional image (fulldome spherical images) shot by an omnidirectional camera (fulldome spherical camera), a panoramic image that has an effective range (also referred to as an effective image range) larger than the display range which can be displayed on a display unit at one time, and the like. The VR image also includes a still image, a moving image, and a live image (image acquired from the camera almost in real time). For example, the VR image has an effective image range of up to 360 degrees in the left-right direction and 360 degrees in an up-down direction. The VR image also includes an image that has a wider angle of view than can be shot with a normal camera or a wider effective range than can be displayed by a display unit at one time, even if the angle is less than 360 degrees in the left-right direction or 360 degrees in the up-down direction. An image captured by the camera 100 by using the lens unit 300 described above is a type of the VR image. The VR image can be displayed in VR, for example, by setting the display mode of a display device (a display device capable of displaying VR images) to “VR view”. By displaying the VR images with a 360-degree angle of view in VR, the user can view omnidirectional images which are seamless in the left-right direction by changing the orientation of the display device in the left-right direction (a horizontal rotation direction).

The VR display (VR view) refers to a display method (display mode) that enables changing the display range. This display method displays an image, out of the VR image, in the visual field range corresponding to the orientation of the display device. VR display includes “monocular VR display” (“monocular VR view”), in which a single image is displayed by applying a deformation that maps the VR image onto a virtual sphere (deformation in which distortion correction is applied). VR display also includes “binocular VR display” (“binocular VR view”), in which a left eye VR image and a right eye VR image are displayed side by side in left and right regions by performing a transformation that maps those images onto a virtual sphere. It is possible to view stereoscopic images by performing a “binocular VR display” using the left eye VR image and the right eye VR image, which have parallax with respect to each other. In any VR display, for example, when the user wears a display device such as a head-mounted display (HMD), the image (video image) is displayed in a visual field range corresponding to the direction in which the user’s face is facing. For example, assume that at a given point in time, a VR image displays an image in a visual field range centered at 0 degrees in the left-right direction (a specific heading, e.g., north) and 90 degrees in the up-down direction (90 degrees from the zenith, i.e., horizontal). If the orientation of the display device is flipped front-to-back from this state (e.g., the display surface is changed from facing south to facing north), the display range is changed to an image of a visual field range centered at 180 degrees in the left-right direction (the opposite heading, e.g., south) and 90 degrees in the up-down direction, of the same VR image. In other words, when the user turns their face from north to south (i.e., turns around) while wearing the HMD, the image displayed on the HMD is also changed from an image of the north to an image of the south. Note that the VR image captured using the lens unit 300 of the present embodiment is a VR180 image of a range of substantially 180 degrees in the front, and there is no image of a range of substantially 180 degrees in the rear. If such a VR180 image is displayed in VR and the orientation of the display device is changed to a side where the image is not present, a blank region is displayed, for example.

By displaying VR images in VR in this manner, the user has a sense of virtually being in the VR image (in a VR space). Note that the VR image display method is not limited to a method of changing the orientation of the display device. For example, the display range may be moved (scrolled) in response to a user operation made using the touch panel, a directional button, or the like. In addition to changing the display range by changing the orientation, the display range may be changed in response to a touch-move made on the touch panel, dragging operations using a mouse or the like, pressing a directional button, or the like during VR display (in the “VR view” display mode). Note that a smart phone attached to VR goggles (head mount adapter) is a type of the HMD.

### Explanation of Each Processing Unit

The following describes an example of a case where the camera 100 and binocular lens unit 300 generate and display an image clearly indicating the presence of occlusion (occlusion display image) in the present embodiment. Display in the present embodiment differs in the purpose of image generation and image display from the binocular VR display in which the left-eye image and the right-eye image are mainly generated for stereoscopic display and these images are displayed side by side in the left and right regions. In the present embodiment, such a technique is provided that enables a photographer to visually recognize occlusion (hiding) occurrence of a subject easily in real time during shooting.

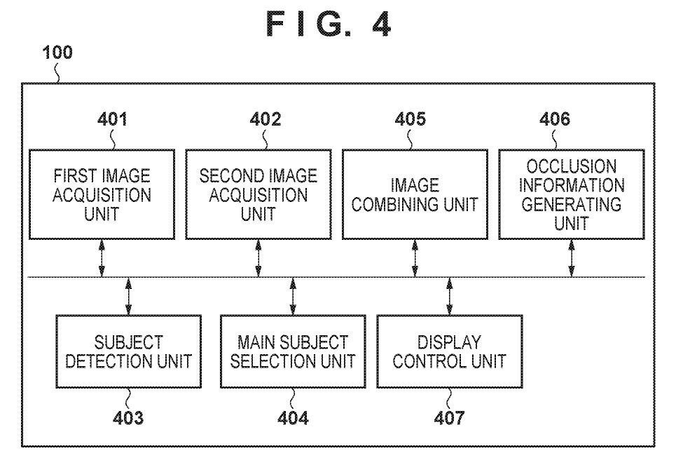

FIG. 4 illustrates an example of a functional configuration of the camera 100 according to the first embodiment. A first image acquisition unit 401 and a second image acquisition unit 402 sequentially acquire captured images, acquired by the imaging unit 211 of the camera 100 via the lens unit 300, as image signals in real time. Assuming that an optical system corresponding to the first image acquisition unit 401 is a right-eye optical system 301R, an optical system corresponding to the second image acquisition unit 402 is a left-eye optical system 301L. That is, the first image acquisition unit 401 and the second image acquisition unit 402 constitute an image acquisition device for acquiring a plurality of (in this case, two) images from a single image signal output from the imaging unit 211. The first image acquisition unit 401 and the second image acquisition unit 402 can acquire a plurality of images captured to include a common subject and to have parallax. Each of the images corresponds to an image obtained through a different optical system of the right-eye optical system 301R and the left-eye optical system 301L. Here, the present embodiment describes the example in which the two images are acquired when the lens unit 300 with the two optical systems is used. However, the present embodiment is also applicable to the case where a plurality of (more than two) images are acquired with a lens unit with more than two optical systems. In addition, the present embodiment describes the case as one example where the first image acquisition unit 401 and the second image acquisition unit 402 each acquire an image, but one image acquisition unit may acquire a plurality of images.

A subject detection unit 403 performs subject detection processing on each of the images acquired by the first image acquisition unit 401 and the second image acquisition unit 402. Subjects such as people, animals, vehicles, and the like, which have been preset as detection targets are detected, and information on locations, sizes, and types of the detected subjects is stored as a list of the subjects in the system memory 219 or the nonvolatile memory 220. The subject detection unit 403 may detect the subjects using known pattern matching or using machine learning models learned by known Deep Learning.

A main subject selection unit 404 selects (determines) a subject for occlusion display when occlusion occurs for the subject detected by the subject detection unit 403. Such selection of the subject is performed in accordance with a selection condition of the main subject set by the photographer in advance. Selection conditions include, for example, at least one of a size of the subject relative to an image angle of view of the subject and a type of the subject. However, the selection condition is not limited to these, and may further include other conditions. That is, the main subject selection unit 404 selects (determines) a specific subject with occlusion from among the detected subjects that satisfy the selection conditions corresponding to being the main subject.

When the main subject is selected in accordance with the size of the subject relative to the image angle of view, for example, a minimum size threshold Lmin for the main subject can be set by the photographer’ operation. In this case, the main subject selection unit 404 selects one or more subjects whose detected subject sizes (e.g., percentage of the subject’s image angle of view) are each larger than the threshold value Lmin as the main subject. The threshold value Lmin can be set, for example, using a percentage of the image angle of view for each eye. At this time, the subject size can be specified, for example, using a length of a long side of a rectangular circumscribed frame surrounding the detected subject.

Moreover, when the main subject is selected in accordance with the type of the subject, the type of the main subject to be selected can be set by the photographer's operation. In this case, the main subject selection unit 404 may, for example, select a subject determined to be a person as the main subject in response to a previous setting in which the type of the main subject to be selected is a person. Note that, when a plurality of selection conditions such as the size of the subject relative to the image angle of view and the type of the subject are set by the photographer’s operation, the main subject selection unit 404 may select a subject as the main subject that satisfies one of the set selection conditions. Alternatively, the main subject selection unit 404 may select as the main subject a subject that satisfies all of the selection conditions set. The main subject selection unit 404 stores the detection results of one or more main subjects as a subject list in the system memory 219 or in the nonvolatile memory 220.

The image combining unit 405 combines the binocular images to generate a composite image (also called a display image or a base image) that is used as the base for occlusion display. Since the binocular images are captured from different viewpoints, if the two images are directly superimposed, the subject with large parallax will appear blurred, resulting in an image as if captured out of focus. Accordingly, the image combining unit 405 generates a composite image that aligns binocular viewpoints to make the image easier for the photographer to see. First, the image combining unit 405 pre-sets a virtual viewpoint position at which binocular image compositing is performed. Here, the virtual viewpoint is set in the middle position between the right-eye optical system 301R and the left-eye optical system 301L. The image combining unit 405 performs viewpoint conversion processing for each of the binocular images (right image and left image) to a virtual viewpoints set respectively by the known perspective projection transformation for the main subject selected by the main subject selection unit 404. For example, in the viewpoint conversion processing, the image combining unit 405 estimates a subject distance for the main subject selected by the main subject selection unit 404, and performs viewpoint alignment processing of the subject in the left and right images in accordance with the subject distance. The image combining unit 405 generates a composite image in which the binocular viewpoints are aligned (i.e., parallax is reduced) by superimposing the image region of the main subject after the viewpoint conversion in the left image and the image region of the main subject after the viewpoint conversion in the right image and performing average processing with use of the result of the viewpoint alignment processing. Here, the image combining unit 405 also performs processing to determine whether each subject has occlusion. For example, the image combining unit 405 can compare the list of the subjects detected by the right-eye optical system 301R and the left-eye optical system 301L, respectively, and can determine that occlusion has occurred based on the results of subject distance estimation for the main subject detected with only one eye. If the image combining unit 405 determines that occlusion has occurred in a particular main subject, a flag indicating that occlusion has occurred is added in the subject list.

The processing to determine whether the main subject in the left image and the main subject in the right image are the same corresponding subject and to estimate the subject distance can be performed by calculating a correlation between the right and left images in a direction along an epipolar line for a rectangular region surrounding the main subject. Such a correlation between the right and left images can be calculated using a known technique such as a sum of absolute difference (SAD) calculation in the direction along the epipolar line, for example. Assuming that the viewpoint spacing between the two eyes and internal parameters of the camera in the perspective projection transformation are known by optical design values of the lens unit 300 and previous camera calibration. When the main subject in the left image and the main subject in the right image are the same corresponding subject and the subject distance can be estimated, the image combining unit 405 can determine that the main subject has no occlusion through the above processing. Moreover, when the subject distance of a certain main subject (e.g., a main subject detected with only one eye) cannot be estimated, the image combining unit 405 can determine that the main subject has occlusion. In this manner, the image combining unit 405 can determine the subject with occlusion among the images.

The processing described above with reference to FIG. 4 can be realized by the system control unit 218 or the image processing unit 214 executing a computer program stored in the nonvolatile memory 220, for example. Moreover, the processing described above with reference to FIG. 4 is not limited to the above description. For example, the image combining unit 405 may pass through an image by one eye of the images that are acquired by the first image acquisition unit 401 or the second image acquisition unit 402.

An occlusion information generating unit 406, for example, generates occlusion information for visually recognizing that the subject, determined to have occlusion in the previous step, has occlusion. Examples of the occlusion information include an image (also called an occlusion display image) that is processed from the base image generated by the image combining unit 405 so that the photographer can visually recognize the subject with occlusion. The occlusion information generating unit 406 can, for example, provide a contour-enhanced display for the occlusion information that emphasizes an outer edge of the subject with occlusion. Such processing can also be realized by the system control unit 218 or the image processing unit 214 executing a computer program stored in the nonvolatile memory 220, for example.

A display control unit 407 controls and processes display of the occlusion display image generated by the occlusion information generating unit 406 on the display unit 108 of the camera 100.

### Series of Operation of Occlusion Information Generation Processing

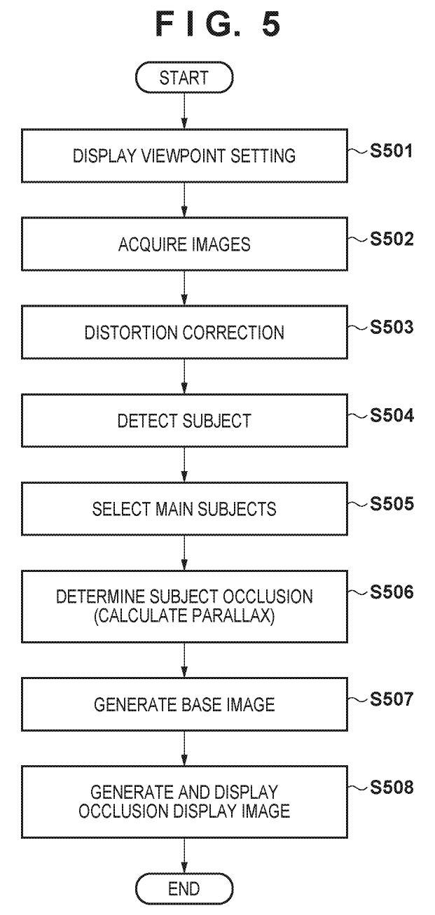

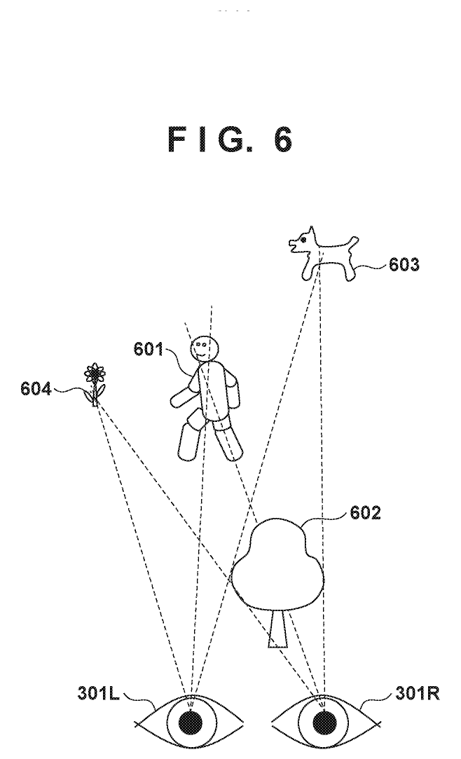

The following describes a series of operation of the occlusion information generation processing with reference to FIG. 5. Note that each element of the camera 100 in FIG. 4 performs a series of operation of the occlusion information generation processing. That is, the occlusion information generation processing can be realized by the system control unit 218 or the image processing unit 214 executing a computer program stored in the nonvolatile memory 220, for example. Note that the occlusion information generation processing according to the present embodiment can be applied, for example, to the case of capturing a shooting scene illustrated in FIG. 6. Specifically, FIG. 6 schematically illustrates the shooting scene captured by the camera 100 to which the lens unit 300 with the right-eye optical system 301R and the left-eye optical system 301L are attached. As described above, the first image acquisition unit 401 corresponds to the right-eye optical system 301R, and the second image acquisition unit 402 corresponds to the left-eye optical system 301L. The right-eye optical system 301R and the left-eye optical system 301L are optical systems with parallax but some partial common field of view. In the shooting scene illustrated in FIG. 6, a person 601 is shielded by a tree 602 in the right-eye optical system 301R, causing occlusion. The other subjects, i.e., an animal 603 and a flower 604, are within the field of view of the both eyes (i.e., right-eye optical system 301R and left-eye optical system 301L). The four subjects illustrated here are limited to those detected in step S504 of subject detection for convenience of explanation, which is to be described below.

In step S501, the image combining unit 405 sets a virtual viewpoint position of the occlusion display image (display viewpoint setting). In later processing, the image combining unit 405 uses the display viewpoint setting to convert the images with different viewpoints acquired with compound eyes into images at one virtual viewpoint position, and generates an image obtained by compositing the images at that virtual viewpoint position. Although the case is described as an example in which a midpoint of the two viewpoints is set as the virtual viewpoint position in this embodiment, such a configuration may be adopted that the photographer sets the virtual viewpoint position by operating the touch panel 109, the operating unit 229, and the like.

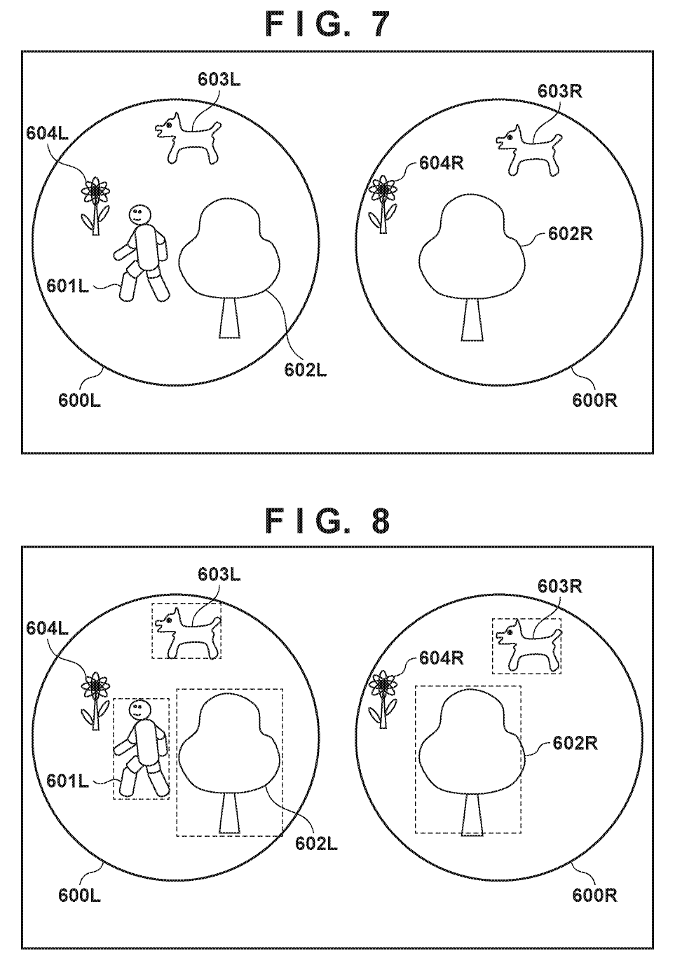

In step S502, the first image acquisition unit 401 and the second image acquisition unit 402 acquire binocular images from the images captured by the two eyes. FIG. 7 illustrates an example of an image captured when the shooting scene shown in FIG. 6 is taken with two eyes. This image illustrates a configuration in which a right-eye image 600R and a left-eye image 600L are captured side by side on one and the same image sensor as the imaging unit 211. However, for convenience of explanation, the example shown in FIG. 7 illustrates a figure in which distortion of the optical systems of both eyes is corrected in step S503. The left-eye image 600L shows images 601L to 604L of four subjects 601 to 604 in FIG. 6, whereas right-eye image 600R shows images 602R to 604R of the subjects 602 to 604. In other words, occlusion has occurred and the image of person 601 does not appear in the right-eye image 600R.

In step S503, the image processing unit 214 performs image distortion correction. Since the lens unit 300 in the present embodiment is a VR180 lens, the captured image in step S502 is an image with distortion. Performing the distortion correction enhances visibility of the photographer, leading to more suitable execution of the step. However, the step may be omitted.

In step S504, the subject detection unit 403 performs subject detection for each of the binocular images. For example, in this step, four subjects shown in FIG. 7 are detected.

In step S505, the main subject selection unit 404 selects main subjects in each of the binocular images. FIG. 8 illustrates that the main subjects are selected from the detected subjects shown in FIG. 7. The subjects selected as the main subjects are each indicated in the figure by a dashed rectangle surrounding the subject. For example, when a size of the long side of the circumscribed frame surrounding the detected subject is defined as a subject size, a subject whose subject size is 20% or more of widths of the fields of view of the right-eye image 600R and left-eye image 600L can be considered the main subject. In the example shown in FIG. 8, the flower 604 does not meet the selection condition, indicating that it is not selected as the main subject.

In step S506, the image combining unit 405 performs subject occlusion determination. At this time, the image combining unit 405 calculates parallax of each subject. For the person 601 with occlusion, the image combining unit 405 cannot find the image region of the right eye corresponding to the image 601L of the person 601 in the left eye by calculating the correlation of the right and left images by the image combining unit 405. That is, for example, in the image region of the right eye corresponding to the image 601L of the person 601 in the left eye, no correlation value appears that exceeds the threshold indicating high correlation. In such a case, the image combining unit 405 cannot calculate the parallax for the image 601L of the person 601 in the left eye (i.e., cannot estimate the subject distance) and determines that occlusion has occurred. For other subjects, there are image regions where the correlation is high for both eyes (the correlation value exceeds the threshold value), and a parallax amount can be calculated. The tree 602 has a short subject distance, and a large parallax amount is calculated. On the other hand, the animal 603 is a distant subject, and a small parallax amount is calculated. The image combining unit 405 can determine that there is no occlusion for the subjects for which the parallax amounts can be calculated.

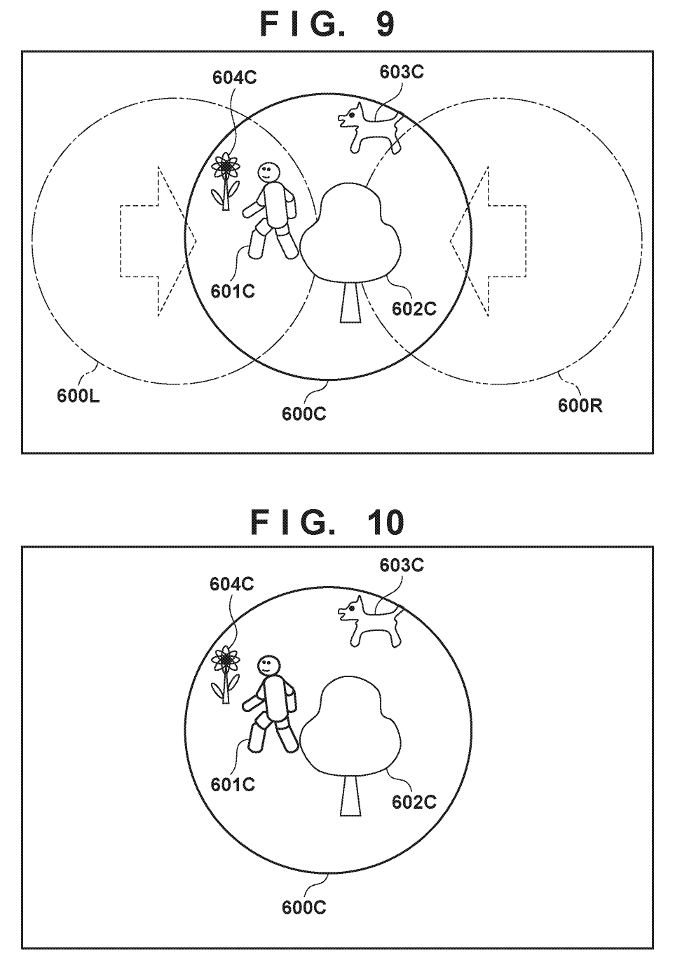

In step S507, the image combining unit 405 generates a composite image (base image) that serves as a base for clarifying occlusion in accordance with the calculated parallax. FIG. 9 illustrates an example of a base image 600C, which is a composite of the binocular images at the set virtual viewpoint position. For the person 601 determined to have occlusion in step S506, an image 600L, where the image of the person 601 exists among the binocular images, is displayed in the base image 600C. The image combining unit 405 performs viewpoint conversion processing of the tree 602 and the animal 603, that are determined to have no occlusion, into the virtual viewpoint positions using the parallax amounts calculated from each of the binocular images. Moreover, the image combining unit 405 superimposes and composites the right and left images after image viewpoint transformation to generate an average image of the binocular images whose viewpoints are converted (i.e., a subject region image with reduced parallax), and adds the composite image on the base image 600C.

In step S508, the occlusion information generating unit 406 generates an occlusion display image. For example, as illustrated in FIG. 10 as one example, the occlusion information generating unit 406 can indicate a subject with occlusion by highlighting an outline of the subject determined to have occlusion. The display control unit 407 displays the image in FIG. 10 on the display unit 108. In the present embodiment, the case has been described as an example in which the occlusion information generating unit 406 generates an occlusion display image to indicate the occurrence of occlusion. However, the present embodiment is not limited to generation of the image as long as it can indicate occurrence of occlusion. That is, the occlusion information generating unit 406 is only necessarily able to generate information for visually recognizing the subject with occlusion in the base image. The above embodiment also describes an example of visually recognizing the subject with occlusion. However, it is not limited to this example. Text or symbols, for example, may be used to generate information for visually recognizing the subject with occlusion. For example, the occlusion information generating unit 406 may generate information for visually recognizing the subject with occlusion by using, for example, text about the subject with occlusion (e.g., by appending the text and the like to the base image).

As described above in the present embodiment, for a subject with occlusion determined based on the correlation between the right and left images, an occlusion display image containing information for visually recognizing the subject by the photographer is generated and displayed on the display unit 108. In this manner, the photographer can visually recognize the occurrence of occlusion in the current shot in real time and easily.

### Second Embodiment

A second embodiment describes a configuration example that further reduces a processing load of the image combining unit 405. The configuration of this embodiment is more suitable when a processing performance of the system control unit 218 of the camera 100 is limited or when high-speed processing is required, such as when shooting at high frame rates.

Note that the configuration of the second embodiment is similar to that of the camera 100 and the like described in the first embodiment. Accordingly, the same reference numbers are used for the same configuration and processing as in the first embodiment, and their explanation is omitted while differences are emphasized.

The following describes occlusion information generation processing according to the present embodiment. Note that, also in the present embodiment, each element of the camera 100 in FIG. 4 performs a series of operation of the occlusion information generation processing. That is, a series of operation of the occlusion information generation processing can be realized by the system control unit 218 or the image processing unit 214 executing a computer program stored in the nonvolatile memory 220, for example.

Steps S501 to S506 are performed by the image combining unit 405 and the like in the same manner as in the first embodiment.

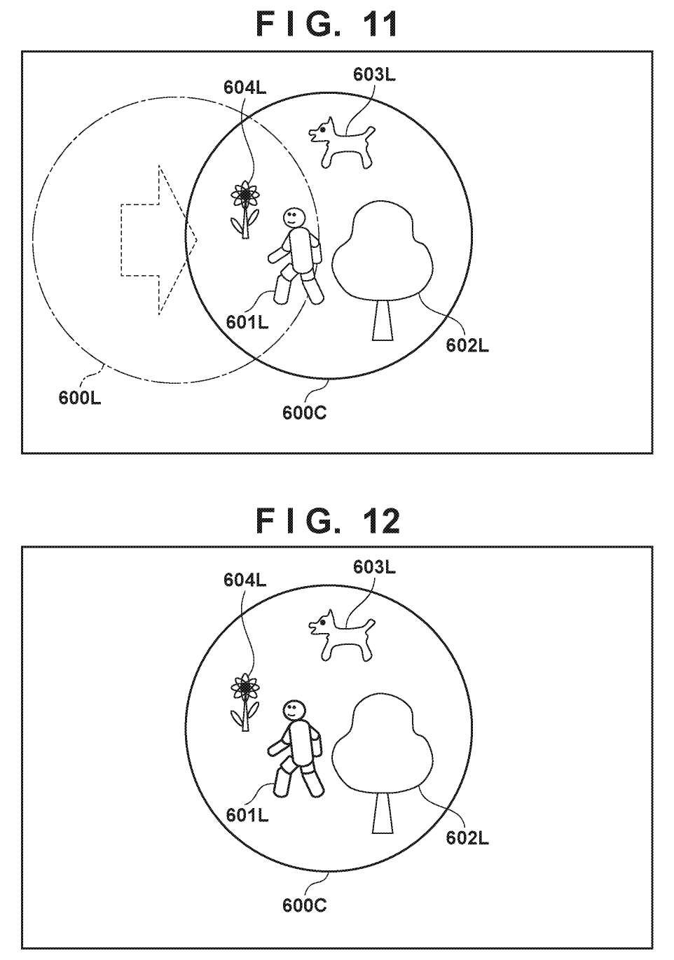

In step S507, the image combining unit 405 compares the list of subjects selected as the main subjects, and generates the base image of the occlusion display image by performing pass-through processing to the image of the eye with the larger number of main subjects. This is because the image by the eye with the larger number of main subjects is considered to have a greater probability of showing a subject with occlusion than the image by the other eye. For example, as illustrated in FIG. 11, the image combining unit 405 performs pass-through processing to the left-eye image 600L, which has the larger number of detected subjects, as the base image 600C for the occlusion display image.

In step S508, the occlusion information generating unit 406 generates an occlusion display image like in the first embodiment, and then the display control unit 407 displays the image on the display unit 108. FIG. 12 illustrates an example of an image displaying occlusion information by highlighting the outline of the subject determined to have occlusion in the present embodiment. If the subject with occlusion does not appear in the pass-through processed image, the occlusion information generating unit 406 obtains a subject position from the list of main subjects recorded by the main subject selection unit 404. Then, the subject with occlusion can be clearly indicated by adding a frame to an approximate location of the subject on the image.

As above, the image combining unit 405 performs the pass-through processing using one of the images with the large number of detected subjects as the base image for the occlusion display image. In this manner, the processing load to generate the occlusion display image can be reduced and the occlusion display image can be displayed on the display unit 108 at high speed. Specifically, by displaying the occlusion display image in FIG. 12 on the display unit 108 by the display control unit 407, the photographer can visually recognize occurrence of occlusion in the current shooting in real time and easily.

### Third Embodiment

In the present embodiment, a display mode of the occlusion display image differs from that in the embodiments described above. For example, the occlusion display image generated in the present embodiment differs from the occlusion display form in FIG. 10 of the first embodiment and FIG. 12 of the second embodiment. Therefore, processing in the occlusion information generating unit 406 in the present embodiment differs from those in the embodiments described above, but the other configurations and processing contents are the same as those in the embodiments described above. Accordingly, the same reference numbers are used for the same configuration as in the embodiments described above, and their explanation is omitted while differences are emphasized.

The following describes occlusion information generation processing according to the present embodiment. Note that, also in the present embodiment, each element of the camera 100 in FIG. 4 performs a series of operation of the occlusion information generation processing. That is, a series of operation of the occlusion information generation processing can be realized by the system control unit 218 or the image processing unit 214 executing a computer program stored in the nonvolatile memory 220, for example.

Steps S501 to S507 are performed by the image combining unit 405 and the like in the same manner as in the embodiments described above. Then, in step S508, the image combining unit 405 generates and displays the occlusion display image from the generated base image 600C of the occlusion display image.

In order to generate and display the images to be presented to the photographer in real time during shooting, it is desirable to be able to select or change an occlusion display form that is suitable in accordance with brightness of the shooting location and the types of the subject being shot.

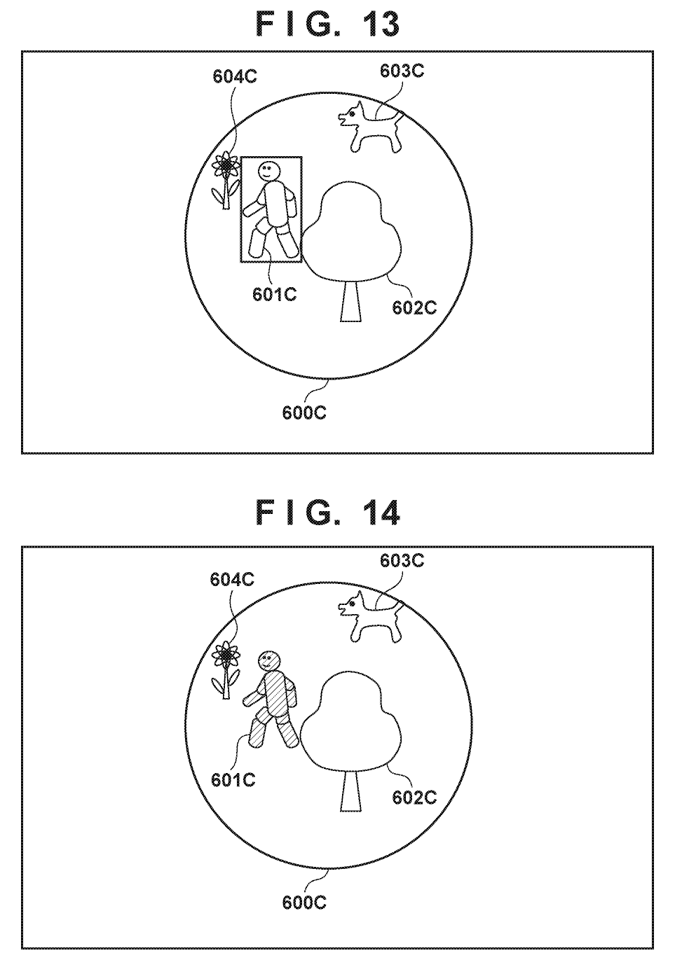

FIG. 13 illustrates an example of an occlusion display image according to the present embodiment. For example, the occlusion information generating unit 406 displays the person 601 with occlusion by means of a “circumscribed frame display” that displays a rectangular frame surrounding the subject. Such a display form is suitable when the size of the subject in the image is relatively small or the shape of the subject is complex, and can make it easier for the photographer to visually recognize the subject with occlusion even in these subject conditions.

FIG. 14 illustrates another example of an occlusion display image according to the present embodiment. For example, the occlusion information generating unit 406 displays occlusion for the person 601 with occlusion by means of a “color/brightness/transparency change display”. Specifically, the occlusion information generating unit 406 generates an occlusion display image in which any of the color, the brightness, or the opacity of the region of the person 601 (specific subject) in the captured original image is changed. Such a display form is suitable for shooting indoors or in a relatively dark environment where the colors and brightness of a live-view screen on the display unit 108 are clearly visible, and makes it easier for the photographer to visually recognize the subjects with occlusion in these shooting environments. Similar to the “contour-enhanced display” shown in the first embodiment, this display form allows the photographer to intuitively recognize the type of the object, making it easy for the photographer to visually recognize which subject has occlusion.

Note that the occlusion information generating unit 406 may combine a plurality of occlusion displays described above. The display form of the occlusion display image according to the present invention is a typical display form, and is not limited to the display form shown in the above embodiments, but may be other display forms similar to these.

According to the present invention, a photographer can visually recognize occlusion occurrence of the subject easily.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-188543, filed October 25, 2024 which is hereby incorporated by reference herein in its entirety.

What is claimed is:

1. An image processing apparatus, comprising:
at least one processor; and
at least one memory coupled to the at least one processor storing instructions that, when executed by the at least one processor, cause the at least one processor to function as:
an image acquisition unit configured to acquire a plurality of images captured in such a manner as to include a common subject and have parallax;
a determining unit configured to determine a specific subject with occlusion among the plurality of images; and
a generating unit configured to generate information enabling visual recognition of occlusion of the specific subject in a display image that is based on at least one of the plurality of images.

2. The image processing apparatus according to claim 1, further comprising
an image generating unit configured to generate the display image based on at least one of the plurality of images,
wherein the image generating unit generates, as the display image, an image captured from a virtual viewpoint different from viewpoints from which the plurality of images were captured.

3. The image processing apparatus according to claim 2,
wherein the image generating unit performs viewpoint conversion to convert each of the plurality of images to an image from the virtual viewpoint, and generates the display image with use of the converted images from the virtual viewpoint.

4. The image processing apparatus according to claim 3,
wherein the image generating unit further estimates a subject distance for a subject included in an image and adds, to the display image, a subject region image with reduced parallax for the subject in the plurality of images in accordance with the subject distance.

5. The image processing apparatus according to claim 1, further comprising:
an image generating unit configured to generate the display image based on at least one of the plurality of images,
wherein the image generating unit uses, as the display image, an image with a larger number of subjects among the plurality of images.

6. The image processing apparatus according to claim 1,
wherein the determining unit determines the specific subject with occlusion in accordance with whether or not a subject distance of a subject detected in a first image among the plurality of images can be estimated.

7. The image processing apparatus according to claim 1,
wherein the determining unit determines the specific subject with occlusion from at least one subject that satisfies a predetermined condition corresponding to being a main subject from among subjects detected in each image among the plurality of images.

8. The image processing apparatus according to claim 7,
wherein the at least one subject that satisfies the predetermined condition is a subject that satisfies a condition regarding at least one of a percentage of an angle of view occupied by the subject and a type of the subject.

9. The image processing apparatus according to claim 1,
wherein the information enabling visual recognition of occlusion of the specific subject includes information obtained by adding, to the display image, at least one of an emphasized outline of a region of the specific subject and a frame circumscribing the region of the specific subject.

10. The image processing apparatus according to claim 1,
wherein the information enabling visual recognition of occlusion of the specific subject includes information obtained by changing any of a color of a region of the specific subject, a brightness of the region of the specific subject, and an opacity of the region of the specific subject in a captured image.

11. The image processing apparatus according to claim 1, further comprising:
a display control unit configured to display, on a display unit, the information generated by the generating unit and enabling visual recognition of occlusion of the specific subject.

12. An image capturing apparatus comprising:
an imaging unit configured to capture an image; and
the image processing apparatus according to claim 1,
wherein the image acquisition unit acquires the plurality of images from one image signal output from the imaging unit.

13. The image capturing apparatus according to claim 12,
wherein each of the plurality of images corresponds to an image obtained through a different optical system among a plurality of optical systems.

14. A method of controlling an image processing apparatus, the method comprising:
acquiring a plurality of images captured in such a manner as to include a common subject and have parallax;
determining a specific subject with occlusion among the plurality of images; and
generating information enabling visual recognition of occlusion of the specific subject in a display image that is based on at least one of the plurality of images.

15. A non-transitory computer-readable storage medium comprising instructions for performing a method of controlling an image processing apparatus, the method comprising:
acquiring a plurality of images captured in such a manner as to include a common subject and have parallax;
determining a specific subject with occlusion among the plurality of images; and
generating information enabling visual recognition of occlusion of the specific subject in a display image that is based on at least one of the plurality of images.
